(19) United States
(12) Patent Application Publication
(10) Pub. No.: US 2018/0196685 A1
(43) Pub. Date: Jul. 12, 2018

(54) KEY SERVICE FOR MANAGING NETWORK COMPONENTS

(71) Applicant: CA, Inc., New York, NY (US)

(72) Inventors: Charles Abraham Dorr, Rollinsford, NH (US); Garry Dean Gerossie, JR., Rochester, NH (US); Adam George Keller, Barrington, NH (US)

(21) Appl. No.: 15/400,044

(22) Filed: Jan. 6, 2017

(51) Int. Cl. G06F 9/455

(52) U.S. Cl. CPC G06F 9/45533; G06F 2009/45562; G06F 9/45558

(57) ABSTRACT

To effectively manage virtualized components, a virtual network manager aggregates components into entities and maintains an entity inventory that indicates available resources within a virtual network. However, aggregating components into entities and managing the entity inventory as components come on/offline can be computationally intensive. To reduce computation time and improve consistency, the virtual network manager uses a key service that associates components with entity keys. When a component is again instantiated within a virtual network, the virtual network manager passes an identifier for the component to the key service to retrieve an associated entity key. The virtual network manager then uses the entity key to quickly determine an entity that comprises the component and updates a record of the entity in the entity inventory with the component's data.

### BACKGROUND

The disclosure generally relates to the field of data processing, and more particularly virtual network monitoring and management.

Software defined networking (SDN) and network functions virtualization (NFV) allow for network and computing services that are typically carried out by dedicated, specialized hardware to be virtualized through software executing on commodity hardware. SDN/NFV can include multiple layers of software virtualization that provide services such as a service chain, virtual machines, routers, switches, hypervisors, etc. Because these services are instantiated through software, a virtual network is dynamic in that available services are rapidly changing to meet demands. For example, if a virtual machine operating as a web server is experiencing high demand, another virtual machine may be instantiated to handle the increased load and then be removed once demand has decreased.

### BRIEF DESCRIPTION OF THE DRAWINGS

Aspects of the disclosure may be better understood by referencing the accompanying drawings.

FIG. 1 depicts an example virtual network management system with a key service for aggregating virtual network components.

FIG. 2 depicts an example virtual network management system with a key service for aggregating virtual network components.

FIG. 3 depicts an example message from a virtual machine service.

FIG. 4 depicts example operations for managing an entity inventory using a key service.

FIG. 5 depicts an example virtual network management system with an entity model generator for adapting entity models to different software versions.

FIG. 6 depicts example entity models.

FIG. 7 depicts example operations for storing an entity with version compatibility numbers.

FIG. 8 depicts example operations for supplying a version compatible entity model.

FIG. 9 depicts an example computer system with a virtual network manager.

### DESCRIPTION

The description that follows includes example systems, methods, techniques, and program flows that embody aspects of the disclosure. However, it is understood that this disclosure may be practiced without these specific details. For instance, this disclosure refers to using a key service in conjunction with managing an inventory of a virtual network in illustrative examples. Aspects of this disclosure can also be applied to managing physical networks or other computing device environments which include a rapidly-changing inventory of available resources. In other instances, well-known instruction instances, protocols, structures and techniques have not been shown in detail in order not to obfuscate the description.

Terminology

This description uses the term “component” as used in the description below encompasses both hardware and software resources. Examples of components include a hypervisor, a virtual machine, a virtual router, a logical interface, a switch, a router, a server, a hub, an access point, a controller, a virtualized network function, etc. A component may also refer to other software-based resources such as an application, a process of an application, database management system, etc. A component may comprise other components. For example, a component can be a service function chain that comprises a virtualized network function(s), a hypervisor(s), a virtual machine(s), an interface(s), a network(s), and a subnet(s) within the network(s). In some instances, components may be referred to as perspectives, devices, instantiation, virtualized service, etc.

This description uses the term “entity” to refer to a collection of one or more components that form a resource within a virtual network. One or more components may work or connect together to perform a function or may be logically related or grouped together. To aid in management of a virtual network, the components are grouped into entities so that available resources can be more easily ascertained. For example, an entity may be a data center that comprises a number of virtual machines, network interfaces, database interfaces, etc. Instead of these components being individually indicated to network management software, the data center entity is provided, and the network management software can ascertain that each of the disparate components are related and function together to provide the data center resource.

This description uses the term “virtual network services” refer to software that provides virtual network functions such as routers, switches, virtual machines, storage, etc. For example, software for virtual network services may be OpenStack for virtual machines, Cisco Application Centric Infrastructure (ACI) for SDN, Juniper Networks Contrail Cloud Platform for NFV.

This description uses the term “version number” to refer to a number that indicates a current iteration or state of software. Version numbers are used to distinguish variations of program code for software. As changes are made to the program code, the version number associated with the software is updated to reflect that the software has changed. For example, a first version of program code may have a version number of 1.0, and after changes to program code, a second version may have a version number of 2.0. The different versions may have different functionality or may process data differently. An indication that data is compatible with a specified software version number signifies that the data is capable of being processed by software corresponding to the specified version number.

Overview

A virtual network includes a number of components that rapidly changes in response to increased or decreased demand. The large and dynamic number of components can be difficult to track and manage. To more effectively manage virtualized components, a virtual network manager aggregates components into entities and maintains an entity inventory that indicates available resources within a virtual network. However, aggregating components into entities and managing the entity inventory as components come on/offline can be computationally intensive. To reduce computation time and improve consistency, the virtual network manager uses a key service that associates components with entity keys. When a component is again instantiated within a virtual network, the virtual network manager passes an identifier for the component to the key service to retrieve an associated entity key. The virtual network manager then uses the entity key to quickly determine an entity that comprises the component and updates a record of the entity in the entity inventory with the component's data.

Example Illustrations for a Virtual Network Manager with a Key Service

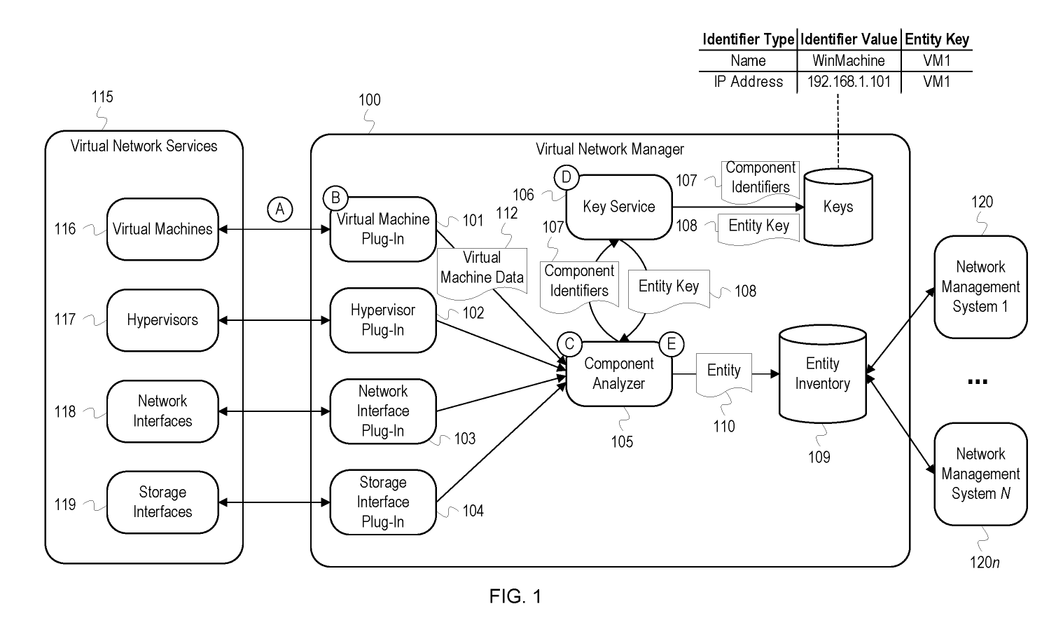

FIG. 1 depicts an example virtual network management system with a key service for aggregating virtual network components. FIG. 1 depicts virtual network services 115 and a virtual network manager 100 that includes plug-ins corresponding to services of the virtual network services 115: a virtual machine plug-in 101, a hypervisor plug-in 102, a network interface plug-in 103, and a storage interface plug-in 104 (collectively referred to as “the plug-ins”). The virtual network manager 100 also includes a component analyzer 105, a key service 106, an entity inventory 109, and a keys database 111. As indicated by the ellipses, the virtual network manager 100 communicates with one or more network management systems including the network management system 1 120 through the network management system N 120n.

Each service within the virtual network services 115 is managed by software designed to provide the virtualized function. The software may be used by network administrators or invoked through program to create or implement instances of the components. The virtual machine service 116 may be used to create one or more virtual machines. The hypervisor service 117 may be used to communicate with one or more hypervisors that manage instantiated virtual machines. The network interface service 118 may be used to create virtualized routers or switches, virtual networks, sub-networks, etc. The storage interface service 119 may be used to create network accessible storage volumes or clusters. One or more software applications may be used to provide each of the virtual network services 115. For example, a hypervisor service 117 may be provided by VMware and OpenStack with each service instantiating one or more hypervisors within a virtual network.

The plug-ins of the virtual network manager 100 poll the virtual network services 115 to retrieve data about instantiated components. Although FIG. 1 depicts plug-ins corresponding to different services in the virtual network services 115, in some embodiments, the virtual network manager 100 may include one or more plug-ins that communicate with all of the virtual network services 115 to collect component data. The component analyzer 105 uses the data to reconcile related components into an entity. An entity comprises components instantiated by one or more of the virtual network services 115. For example, an entity may be web server that comprises a virtual machine component, two network interface components, and a storage volume component. Additionally, a number and type of components within an entity may change over the lifespan of the entity. For example, an entity may be a network that comprises a number of virtualized routers and switches which may increase or decrease in response to network traffic conditions. Aggregating the components into an entity allows the virtual network manager 100 to present virtual network resources as a single device or resource as opposed to disparate component parts. The network management system 1 120 and other network management systems can then poll the entity inventory 109 to determine active or available entities.

At stage A, the virtual machine plug-in 101 of the virtual network manager 100 polls the virtual machine service 116. Each of the plug-ins periodically poll their corresponding virtual network services 115 to retrieve information related to any components that have been instantiated by the services. The virtual network services 115 return messages with data that may provide a number of active components along with attributes, configuration information, status, performance, etc., for each of the components. For example, the virtual machine plug-in 101 may poll the virtual machine service 116 to retrieve information such as the number of active virtual machines and configurations for each of the virtual machines.

At stage B, the virtual machine plug-in 101 processes a message received from the virtual machine service 116 to generate virtual machine data 112. The plug-ins may normalize the received messages, parse and extract data from the messages, reformat the messages, or perform other processing on the messages. For example, the network interface plug-in 103 may determine that additional information related to a network interface is needed and query the network interface service 118 for the information. In FIG. 1, the virtual machine plug-in 101 determines that the message from the virtual machine service 116 indicates that one virtual machine is instantiated. The virtual machine plug-in 101 further parses the message to determine data for the virtual machine, such as properties or configuration information, and puts the data in the virtual machine data 112. The virtual machine plug-in 101 may also format the virtual machine data 112 to be in a normalized format that is compatible with the component analyzer 105. The virtual machine plug-in 101 sends the virtual machine data 112 to the component analyzer 105.

At stage C, the component analyzer 105 processes the virtual machine data 112 to determine component identifiers 107. The component analyzer 105 analyzes the virtual machine data 112 to determine a property that may be used to uniquely identify the virtual machine component as well as other components that may be related to the virtual machine component. The component analyzer 105 may be configured to use a specific property value as an identifier for each virtual network service, e.g. an IP address for a router, a volume name for a storage device, a name for a hypervisor, etc. The component analyzer 105 may also use a combination of properties to uniquely identify a component, such as a virtual disk name and a name of a volume on which a virtual disk is stored. In FIG. 1, the component identifiers 107 in the virtual machine data 112 include a name of the virtual machine, “WinMachine,” and an Internet Protocol (IP) address for the virtual machine, “192.168.1.101.”

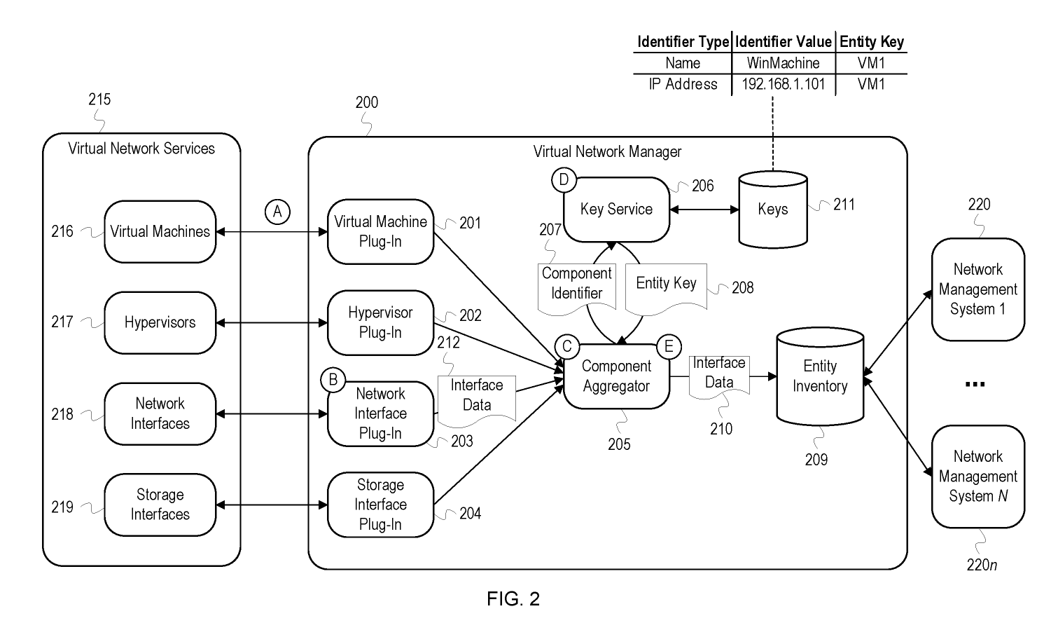

The component identifiers 107 are selected to aid in identifying other components that function together as an entity. For example, as described in more detail in FIG. 2, the IP address of the virtual machine data 112 may match the IP address of a virtualized network interface, indicating that the two components form an entity. The component analyzer 105 consistently selects the same properties as identifiers for components to avoid inconsistency with identifiers stored in the keys database 111. In some embodiments, the plug-ins, instead of the component analyzer 105 may perform operations for selecting identifiers from component data. After determining the component identifiers 107, the component analyzer 105 passes the component identifiers 107 to the key service 106.

At stage D, the key service 106 determines that the component identifiers 107 are not associated with an entity key in the keys database 111. The key service 106 queries the keys database 111 using the component identifiers 107 (“WinMachine” and “192.168.1.101”) and determines that an entry for the component identifiers 107 does not exist. Since no entry exists, the key service 106 creates an entity key 108 of “VM1” and associates the entity key 108 with the component identifiers 107 in the keys database 111. The key service 106 also passes the entity key 108 to the component analyzer 105. Determining that an entry exists for the component identifiers 107 in the keys database 111 indicates that the component associated with the component identifiers 107 has previously been aggregated into an entity. In instances where an associated entity key is not found, the key service 106 may return a newly created entity key along with a message indicating that the entity key is for a new entity.

At stage E, the component analyzer 105 stores the virtual machine data 112 as an entity 110 in the entity inventory 109. The component analyzer 105 may associate the entity 110 with the entity key 108 to allow for identification of the entity 110 as additional components that belong in the entity 110 are detected. Additionally, by associating the entity 110 along with the entity key 108, the entity 110 can be retrieved from the entity inventory 109 by querying the entity inventory 109 using the entity key 108.

FIG. 1 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 2 depicts an example virtual network management system with a key service for aggregating virtual network components. FIG. 2 depicts virtual network services 215 and a virtual network manager 200 that includes plug-ins corresponding to services of the virtual network services 215: a virtual machine plug-in 201, a hypervisor plug-in 202, a network interface plug-in 203, and a storage interface plug-in 204 (collectively referred to as “the plug-ins”). The virtual network manager 200 also includes a component aggregator 205, a key service 206, an entity inventory 209, and a keys database 211. As indicated by the ellipses, the virtual network manager 200 communicates with one or more network management systems including the network management system 2 220 through the network management system N 220n.

At stage A, the network interface plug-in 203 polls the network interface service 218. the network interface plug-in 203 polls the network interface service 218 to retrieve information such as the number of active interfaces and their properties. At stage B, the network interface plug-in 203 processes a message received from the network interface service 218 to generate interface data 212. In FIG. 2, the network interface plug-in 203 determines that the message from the network interface service 218 indicates that one interface is instantiated. The network interface plug-in 203 further parses the message to determine data for the interface, such as properties or configuration information, and puts the data in the interface data 212. The network interface plug-in 203 sends the interface data 212 to the component analyzer 205.

At stage C, the component analyzer 205 processes the interface data 212 to determine component identifiers 207. The component analyzer 205 analyzes the interface data 212 to determine a property that may be used to uniquely identify the virtual machine component. In FIG. 2, the component identifier 207 in the interface data 212 is an IP address name of the interface which is “192.168.1.101.” The component analyzer 205 is configured to use the IP address as an identifier for components that are a network interface type. After determining the component identifier 207, the component analyzer 205 passes the component identifier 207 to the key service 206.

At stage D, the key service 206 determines that the component identifier 207 is associated with an entity key in the keys database 211. The key service 206 queries the keys database 211 using the component identifier 207 (“192.168.1.101”) and determines that an entry for the component identifier 207 exists. In the example of FIG. 2, the key service 206 discovers that the component identifier 207 is associated with an entity key 208 of “VM1.” The key service 206 passes the entity key 208 to the component analyzer 205. Determining that an entry exists for the component identifier 207 in the keys database 211 indicates that the component associated with the component identifier 207 is part of an existing entity.

At stage E, the component analyzer 205 uses the entity key 208 to associate the interface data 212 with an entity corresponding to the entity key 208 in the entity inventory 209. The component analyzer 205 may modify an existing entity data structure in the entity inventory 209 to include the interface data 212. Alternatively, the component analyzer 205 may store the interface data 212 along with the entity key in the entity inventory 209. By associating the interface data 212 with the entity key, all components for an entity can be retrieved from the entity inventory 209 by querying the entity inventory 209 using the entity key. In the example of FIG. 2, the interface data 212 is added to an entity “VM1,” which may also include the virtual machine data 112 from FIG. 1. As a result, retrieving the entity “VM1” from the inventory results in data for both the interface and the virtual machine.

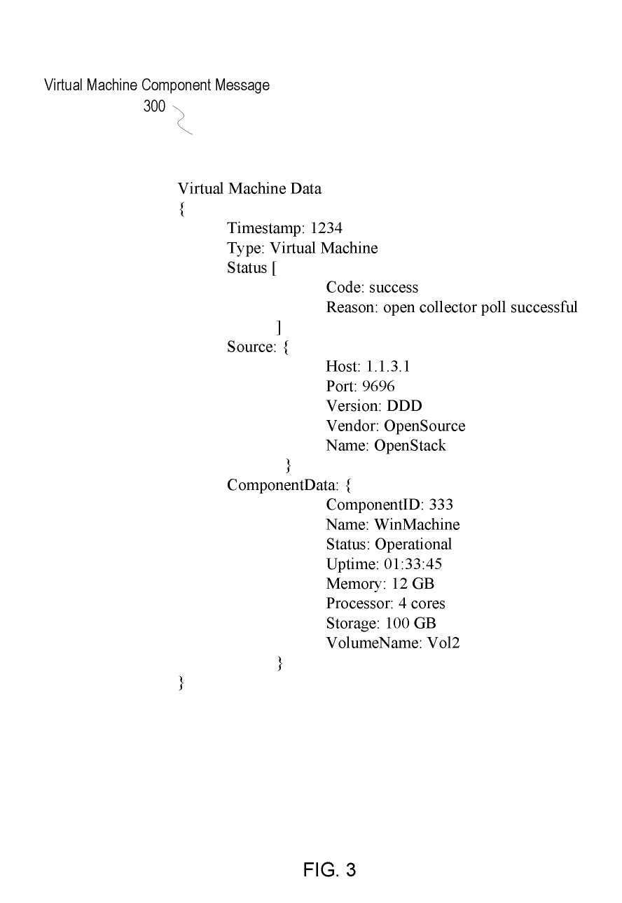

FIG. 3 depicts an example message from a virtual machine service. FIG. 3 depicts a message 300 that includes virtual machine data. The message 300 may have been output from the virtual machine service 116 in response to a request or polling from the virtual machine plug-in 101 as described in FIG. 1.

In this example, the message 300 includes data related to attributes of the message 300. For example, the message 300 includes a timestamp indicating a time of the message and a type of message having a value of “virtual machine,” which also indicates a type of component indicated in the message. The message 300 also includes a status of the message, which includes a code and a reason for the message. In this example, the code is set to a value of success, and the reasons is set to “open collector poll successful.” The message 300 includes a source of the message 300. The source includes a host identifier having a value of 1.1.3.1 and a port number having a value of 9696. The source also includes a version of the message having a value of DDD and name of a vendor of the network component. In this example, the network component is a virtual machine and the vendor is OpenSource which may be a virtual machine service similar to the virtual machine service 116. The source includes a name for the virtual network service or technology that generated the data, which is OpenStack.

The message 300 includes a component data section which includes various data related to an instantiated virtual machine. The component includes an identifier for the component of “333” and a name of “WinMachine.” The component data also includes a status and operational time or uptime for the virtual machine. Additionally, various configuration information for the component is included, such as memory, processor, storage, and a volume name. The component data section can include more or fewer attributes based on a number or amount of resources allocated to the virtual machine component.

The message 300 may include data that will be discarded after processing by a plug-in or a component aggregator of a virtual network manager. For example, a plug-in may normalize the message 300. Normalization may include redefining of different network components that are of different technology types to a common or generic network component representative, wherein the common or generic network component can be representative of each of the different network components that have been redefined. For example, a first version of a virtual machine from technology type A can be limited to attributes that include an identifier (e.g., Universal Unique Identifier (UUID), a name, and an associated Media Access Control (MAC) address, while a second version of a virtual machine from technology type B can have a larger set of attributes defining the virtual machine. Both versions of the virtual machine can be normalized to create a common virtual machine that is representative of both versions. In other words, the normalized virtual machine is not technology specific. Rather, the normalized virtual machine can be defined as technology agnostic. In the context of FIG. 3, a plug-in may normalize the component data section of the message 300 by removing attributes that are not common across virtual machine services executing within a virtual network. For example, another virtual machine service may not indicate an allocated amount of memory, so the plug-in may remove memory from the message 300 prior to passing the message 300 to a component aggregator or other process of a virtual network manager.

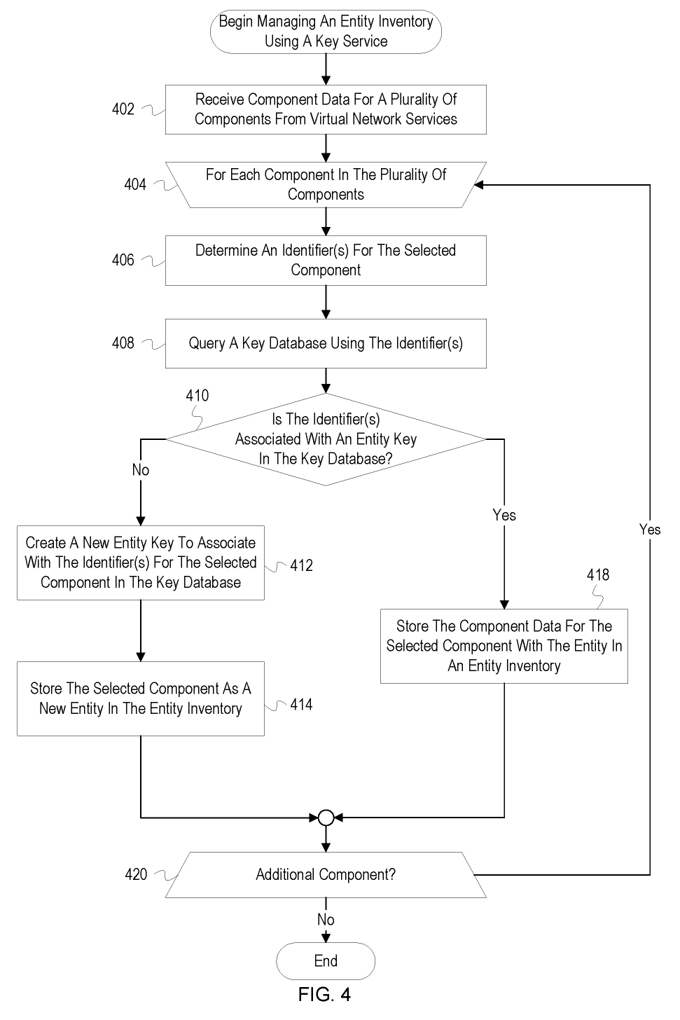

FIG. 4 depicts example operations for managing an entity inventory using a key service. FIG. 4 refers to a virtual network manager similar to the virtual network manager 100 described in FIG. 1 as performing the operations even though identification of program code can vary by developer, language, platform, etc.

The virtual network manager (“manager”) receives component data for a plurality of components from virtual network services (402). The manager includes plug-ins or processes that poll and monitor services running with a virtual network. The plug-ins periodically submit requests for data related to components instantiated by the virtual network services. The plug-ins may then format or normalize the received component data for further processing.

The manager begins operations for aggregating components into entities within an entity inventory database using a key service (404). The component whose component data is currently being analyzed is hereinafter referred to as “the selected component.”

The manager determines one or more identifiers for the selected component (406). The manager analyzes component data for the selected component to identify one or more properties or configuration information that can be used to identify the component. The manager may be configured to select certain properties for component types, such as an IP address for a web server, a physical address for a storage volume, etc. The selected properties are intended to help identify the selected identify as well as other components that may be related to the selected component and, thus, belong with the selected component in an entity. For example, if the selected component is a hypervisor, the manager may select properties such as the name of the hypervisor and the names of virtual machines that are managed by the hypervisor. When virtual machine components are detected, their names may be used to aggregate the components into an entity with the hypervisor.

The manager queries a key database using the one or more identifiers for the selected component (408). The key database includes associations of component identifiers with entity keys. The entity keys represent entities that were previously created by the manager. By querying the key database, the manager is attempting to determine whether the selected component is related to a previously created entity.

The manager determines whether the one ore more identifiers are associated with an entity key in the key database (410). If the query with the identifiers returns a result, the manager determines that the selected component is associated with an entity key and, therefore, an existing entity. If the query with the identifiers does not return a result, the manager determines that the unique identifier is not associated with an entity key and, therefore, is not related to an existing entity.

If the identifiers are not associated with an entity key, the manager creates a new entity key to associate with the identifiers for the selected component in the key database (412). The manager maintains associations of component identifiers and entity keys in the key database so that new entities are not generated for known components as they come on/offline in the future and so that the known components are consistently aggregated with a same entity. The manager may determine the entity key based on a type of the selected component, based on a configured namespace, or based on a sequentially increasing number. For example, if a component type within an entity is a router, the manager may create the entity key “Router1.1.1.2” for the entity, and if a component type is an interface, the manager may create the entity key of “Interface1.1.1.2.”

The manager stores the selected component as a new entity in the entity inventory (414). The manager may store the selected component along with the entity key. As other components are instantiated, components may be added to the entity of the selected component, or the selected component maybe aggregated into and associated with another entity. For example, if the selected component is a network interface, the selected component may be stored as its own entity until it is determined that the selected component is part of a larger entity, such as a virtual machine or storage system.

If the manager determines the identifiers for the selected component are associated with an entity key (410), the manager stores the component data for the selected component with the entity in the entity inventory (418). Because the selected component has already been aggregated into an entity, the entity inventory likely includes an entry for the entity. As a result, the manager may use the entity key to search the entity inventory to identify any entries for the entity. The manager may then add an entry for the selected component or modify the existing entity entry to include component data for the selected component. If no entity associated with the entity key can be found, the manager may create a new entity entry in the entity inventory which comprises the component.

After storing component data in the entity inventory, the manager determines whether there is an additional component (420). If there is an additional component, the manager selects the next component (404). If there is not an additional component, the process ends.

Example Illustrations for a Virtual Network Manager with an Entity Model Generator

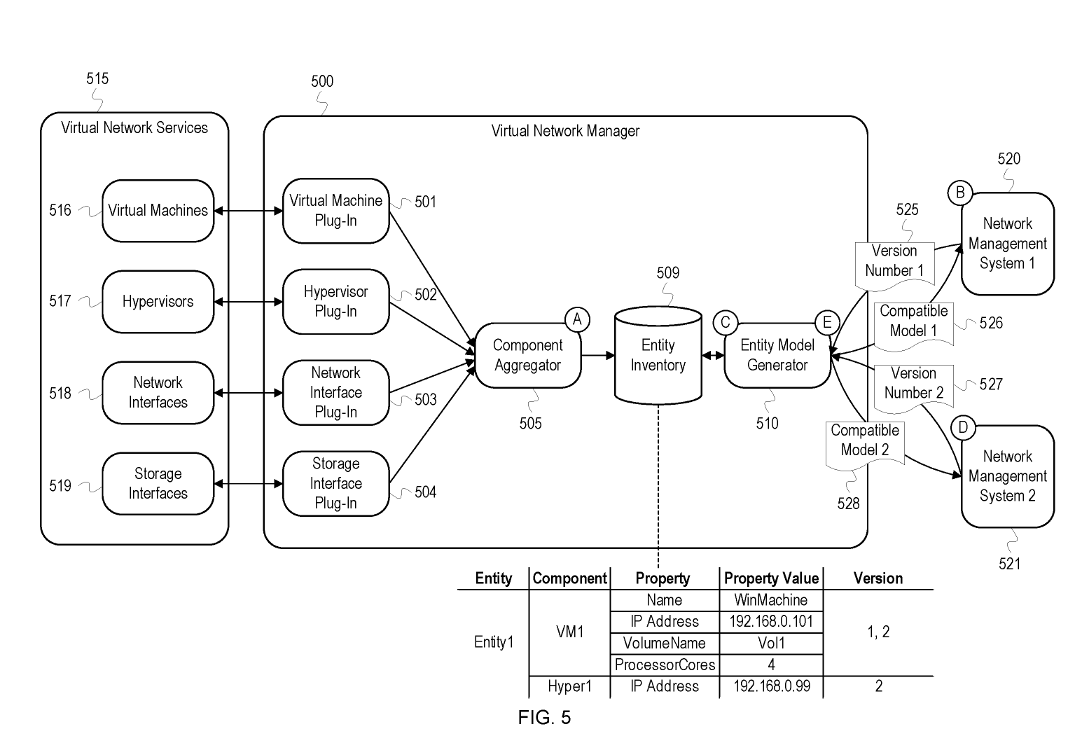

FIG. 5 depicts an example virtual network management system with an entity model generator for adapting entity models to different software versions. FIG. 5 depicts virtual network services 515 and a virtual network manager 500 that includes plug-ins corresponding to services of the virtual network services 515: a virtual machine plug-in 501, a hypervisor plug-in 502, a network interface plug-in 503, and a storage interface plug-in 504 (collectively referred to as “the plug-ins”). The virtual network manager 500 also includes a component aggregator 505, a key service 506, an entity inventory 509, and an entity model generator 510. The virtual network manager 500 communicates with one or more network management systems including a network management system 1 520 and a network management system 2 521.

At stage A, the component aggregator 505 stores entity data in the entity inventory 509 along with version compatibility numbers. The plug-ins of the virtual network manager 500 poll the virtual network services 515 and retrieve component data in a manner similar that described in FIG. 1. Also, the component aggregator 505 aggregates components into entities and stores the entities in the entity inventory 509 in a manner similar to that described in FIG. 1. In FIG. 5, the component aggregator 505 also tags component or entity data with a version number. The version number indicates a version with which the associated data is compatible. For example, as shown in the example data for the entity inventory 509, an entity “Entity1” comprises two components: a virtual machine “VM1” and a hypervisor “Hyper1.” The component “VM1” is compatible with a version number 1 525 (“1”) and a version number 2 527 (“2”). The component “Hyper1” is only compatible with the version number 2 527. The entity model generator 510 determines version compatibility numbers for components based on configuration information input by a user. The configuration information may identify component types, properties, virtual network services, relationships, etc., and include a version compatibility number for any related data. For example, the configuration information may indicate that any data related to components instantiated by the storage interface service 519 is only compatible with the version number 2 527.

At stage B, the network management system 1 520 requests entity data from the entity model generator 510. The network management system 1 520 includes the version number 1 525 in its request. The version number 1 525 indicates a version of an entity model that is compatible with the network management system 1 520. The version number 1 525 may correspond to a software version of a network management system or a version number of a plug-in for the virtual network manager 500 that is executing on a network management system. For example, the network management system 1 520 may include a plug-in whose version number is the version number 1 525, indicating that the plug-in can only interpret data that is compatible with the version number 1 525. The network management system 1 520 may submit different version numbers depending on the data being requested. In some implementations, the network management system 1 520 submits the version number 1 525 during an initial registration process with the virtual network manager 500. The entity model generator 510 then continues to use the registered version number when generating models for the network management system 1 520.

At stage C, the entity model generator 510 generates a compatible model 1 526 based on the version number 1 525. The entity model generator 510 retrieves data from the entity inventory 509 that is compatible with the version number 1 525. In FIG. 5, the entity model generator 510 retrieves the component “VM1” which is indicated as compatible with the version number 1 525 in the entity inventory 509. The entity model generator 510 does not retrieve data related to the component “Hyper1” since this data is not indicated as compatible with the version number 1 525. In some implementations, the entity inventory 509 may also include entries that indicate relationships between components. For example, the entity inventory 509 may indicate that the component “VM1” is a child of or is managed by the component “Hyper1.” Similar to the components, the relationship indication may also be associated with a version number, as only some versions of software may be able to process the relationship.

In addition to being associated with component data, version numbers can also be associated with data formats. For example, the version number 1 525 may require that data be provided in a JavaScript Object Notation (JSON) format while the version number 2 527 requires that data be provided in an extensible markup language (XML) file. After retrieving the data from the entity inventory 509, the entity model generator 510 determines a specified data format associated with the version number 1 525, formats the retrieved data accordingly to generate the compatible model 1 526, and provides the compatible model 1 526 to the network management system 1 520.

At stage D, the network management system 2 521 transmits a request for entity data to the entity model generator 510 along with the version number 2 527. At stage E, the entity model generator 510 generates a compatible model 2 528 based on the version number 2 527. The entity model generator 510 generates the compatible model 2 528 in a manner similar to that of the compatible model 1 526; however, the compatible model 2 528 also includes data related to the component “Hyper1” since this data is compatible with the version number 2 527. Additionally, the compatible model 2 528 may be formatted differently based on which data format is associated with the version number 2 527.

FIG. 5 describes the component aggregator 505 as determining version compatibility numbers for entity data. In some implementations, the plug-ins of the virtual network manager 500 may determine version compatibility numbers for components as the data is retrieved from the virtual network services 515.

FIG. 5 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

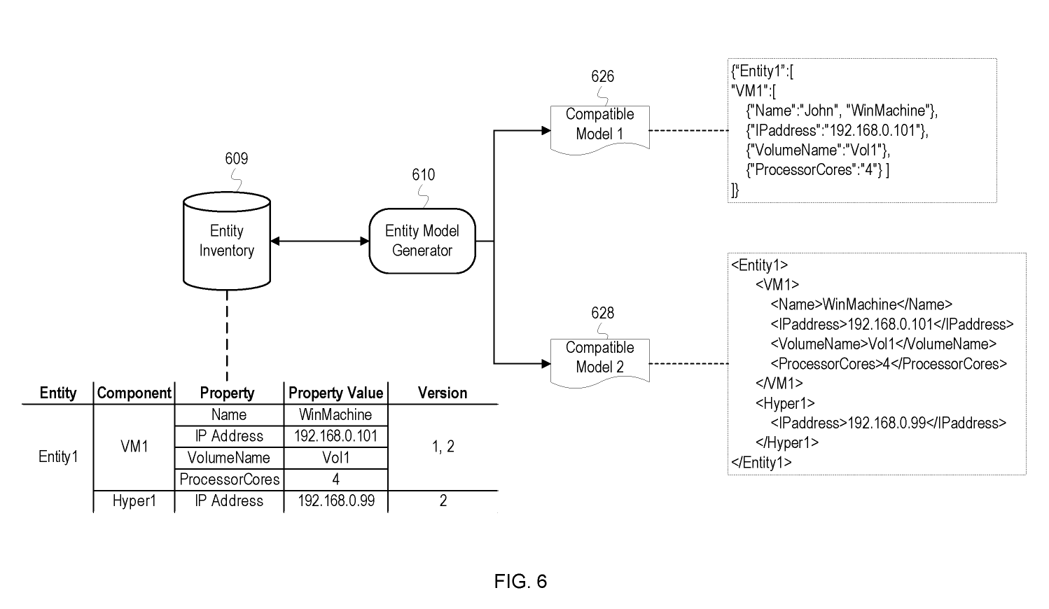

FIG. 6 depicts example entity models for the compatible model 1 626 and the compatible model 2 628 described in FIG. 6 above. The entity model generator 610 retrieves the data for each model from the entity inventory 609. The entity model generator 610 generates the compatible model 1 626 using data compatible with the version number 1. Additionally, the entity model generator 610 determines that the version number 1 is associated with a JSON data format and formats the compatible data into the JSON format as illustrated in FIG. 6 for the compatible model 1 626. The entity model generator 610 generates the compatible model 2 628 using data compatible with the version number 2. Additionally, the entity model generator 610 determines that the version number 2 is associated with an XML data format and formats the compatible data into the XML format as illustrated in FIG. 6 for the compatible model 2 628.

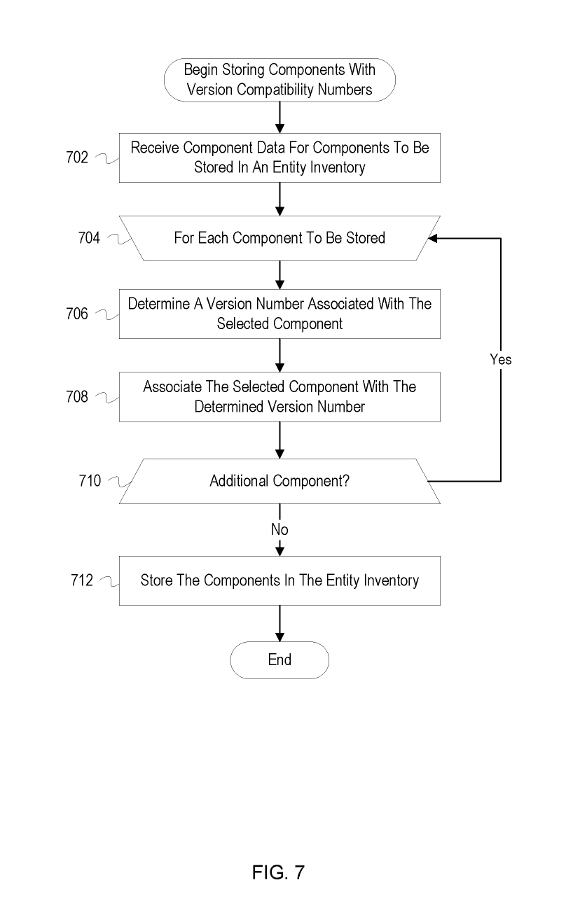

FIG. 7 depicts example operations for storing components with version compatibility numbers. FIG. 7 refers to a virtual network manager similar to the virtual network manager 500 described in FIG. 5 as performing the operations even though identification of program code can vary by developer, language, platform, etc.

A virtual network manager (“manager”) receives component data for components to be stored in an entity inventory (702). The manager receives the component data for a plurality of components through plug-ins which poll virtual network services. Another process of the manager then aggregates the components into one or more entities for storage in the entity inventory.

The manager begins analyzing each component to be stored (704). The component currently being analyzed is hereinafter referred to as “the selected component.”

The manager determines a version number associated with the selected component (706). Some components may not be supported by all versions of client software which subscribe to the manager for entity data or request entity data from the manager. Therefore, the manager associates each component with a version compatibility number. The manager determines a version number for the selected component by consulting a table which indicates version numbers for specified component types. The table may also specify different version numbers for a component type within a specified entity. For example, a component type for a first entity may have a different version number than the same component type for a second entity. The table may be provided by an administrator of the manager or may be determined based on configuration information indicated in program code of the manager.

The manager associates the selected component with the determined version number (708). In some implementations, the entity inventory may be a database that includes a field for a component's version number. In these implementations, the manager associates the selected component with the version number by storing the selected component in the entity inventory along with the version number. In other implementations, the entity inventory may be an object database that stores entities as JSON objects. In such implementations, the manager modifies a JSON data structure of the entity to include a version number field with the determined version number for the selected component.

The manager determines whether there is an additional component to be analyzed (710). In some implementations, the manager may also determine whether any remaining components are of the same property type as the selected component and associated the determined version number to those components as well. If there is an additional component, the manager selects the next component in the entity (704).

If there are no additional components, the manger stores the components in the entity inventory (712). The manager stores the components according to a database type of the entity inventory. If the component information was previously stored in the entity inventory as described in the operations above, the manager may finish storing the components by also storing an entity key or associating each of the components with an entity key for an entity.

FIG. 7 describes the manager associating version numbers with each property. In some implementations, the manager may associate version numbers at a higher or lower level of granularity. For example, the manager may associate version numbers at a component property level or at an entity level. This may occur when data for new types of component properties or entities within a virtual network are only supported in a later software version.

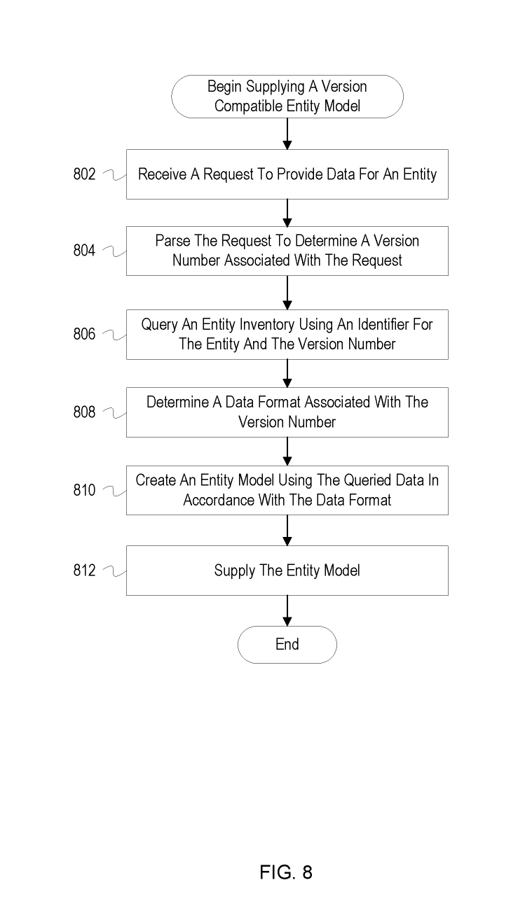

FIG. 8 depicts example operations for supplying a version compatible entity model. FIG. 8 refers to a virtual network manager similar to the virtual network manager 500 described in FIG. 5 as performing the operations even though identification of program code can vary by developer, language, platform, etc.

A virtual network manager (“manager”) receives a request to provide data for an entity (802). The request may be received from network management software or another application which uses information about entities within a virtual network. A requesting device may be a device that has previously subscribed or registered with the manager to receive periodic updates about entities within a virtual network. The request may be received over a network or locally if the manager executes on a same system as the requestor. The request may be generated through an application programming interface (API).

The manager parses the request to determine a version number associated with the request (804). The version number may be the same as a version of software executed by the requesting device. In some instances, the version number may be associated with a particular entity model type or entity data that the requesting device seeks to retrieve. The version number may be included as a data field within the request itself, so the manager may parse data of the request to identify the data field with the version number. In instances where requesting devices register with the manager, the requesting devices may provide version numbers during the registration process. In such instances, the manager determines a source of the request, which may be indicated in the request or within header information. The manager then uses an identifier for the source of the request to determine which version number was provided during registration.

The manager queries an entity inventory using an identifier for the entity and the version number (806). The manager may determine an identifier for the entity from the request. In some instances, instead of an entity identifier, the manager may query for entities of a specified entity type, recently added entities, recently modified entities, etc. The query also includes the version number so that only data compatible with the version is returned with the query. Based on the version number, the query may not return data for some entities, components, relationships, or properties indicated in the entity inventory. For example, an entity may be a data center that includes hypervisors who in turn include virtual machines. The entity inventory indicates that the data center entity is a parent of the hypervisors and that the hypervisors are parents of the virtual machines; however, some versions may not be able to process (i.e. understand) the relationship between the data center and the hypervisors. As a result, in some entity models, only the relationship between hypervisors and virtual machines will be indicated.

The manager determines a data format associated with the version number (808). The manager may be configured to format the entity data differently based on the version number received with the request. For example, the manager may use a template for formatting entity data and each version number may use a different template. In some instances, the format associated with the version number may be preempted by a data format indicated in the received request. Additionally, some devices may indicate a desired data format during a registration process with the manager.

The manager creates an entity model using the queried data in accordance with the data format (810). For example, the manager may format the data into JSON objects, an XML file, etc.

The manager supplies the entity model (812). The manager transmits the entity model to the requesting device. In some embodiments, the manager determines whether a communication protocol is associated with the version number. For example, some software versions may use the HyperText Transfer Protocol (HTTP) and others may use the Secure HyperText Transfer Protocol (HTTPS) to communicate. If a communication protocol is associated with the version number, the manager transmits the entity model to the requesting device in accordance with the associated communication protocol.

FIG. 8 depicts operations for supplying a single entity model. The same operations can be repeated to supply two or more entities.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 412 and 414 of FIG. 4 can be performed in parallel or concurrently. Additionally, the operations depicted in block 808 of FIG. 8 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as component data or properties within component data. In some implementations, component data may be iterated over according to an ordering of components, an indication of component importance, a timestamp associated with component data, component/property types, etc. Also, the number of iterations for loop operations may vary. Different techniques for processing component data may require fewer iterations or more iterations. For example, data for multiple components may be processed or correlated in parallel.

Version numbers may be indicated in a variety of ways. For example, FIG. 4 depicts listing each compatible version within a field in a database. In some implementations, backwards compatibility may be assumed so only the number of a most recent version with which a property is compatible will be indicated.

In the description above, version numbers are stored along with associated data in an entity inventory. In some implementations, version numbers may not be stored in an entity inventory. Instead, version numbers may be associated with data filtering rules that govern which data is included in entity models and supplied to network management systems. For example, a version number may be associated with a filter rule to exclude components of a specified type. When a request for entity data associated with a version number is retrieved, a virtual network manager may retrieve data from the entity inventory, process the data according to filter rules corresponding to the version number, and generate entity models with the remaining data.

In the description above, when it is determined that a component is not associated with an entity key, a virtual network manager creates a new entity for the component. In some implementations, instead of creating a new entity, the manager attempts to aggregate a component with existing entities or other components not already associated with an entity key. To aggregate a component, the manager compares property values in the selected component's data to values of other components of the plurality of components and to component data stored in an entity inventory. The entity inventory stores component data for components that have previously been aggregated into entities. If the manager determines based on the property value comparisons that a set of components are related, the manager aggregates the data of the set of components into an entity. The manager then stores an entity key along with unique identifiers for the aggregated components in a key database. Since aggregating components into entities can be computationally expensive, the manager maintains records of aggregated components in the key database so that components do not have to be re-aggregated as they come on/offline in the future. The manager also stores component data for the aggregated components as an entity in the entity inventory.

The variations described above do not encompass all possible variations, implementations, or embodiments of the present disclosure. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

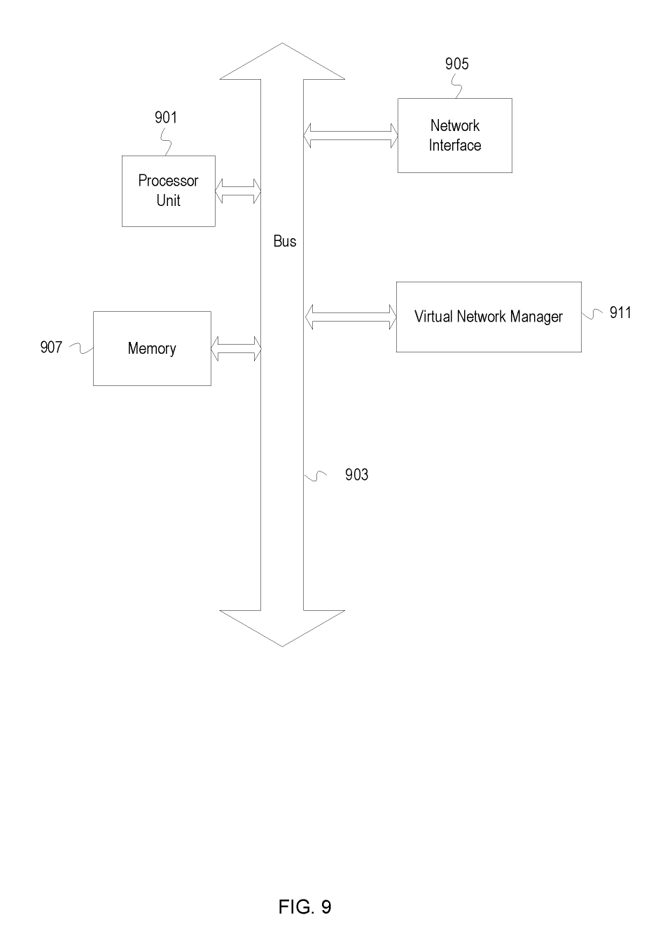

FIG. 9 depicts an example computer system with a virtual network manager. The computer system includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport® bus, InfiniBand® bus, NuBus, etc.) and a network interface 905 (e.g., a Fiber Channel interface, an Ethernet interface, an interne small computer system interface, SONET interface, wireless interface, etc.). The system also includes a virtual network manager 911. The virtual network manager 911 maintains an entity inventory using a key service and adapts data models to different software versions. Any one of the previously described functionalities may be partially (or entirely) implemented in hardware and/or on the processor unit 901. For example, the functionality may be implemented with an application specific integrated circuit, in logic implemented in the processor unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901 and the network interface 905 are coupled to the bus 903. Although illustrated as being coupled to the bus 903, the memory 907 may be coupled to the processor unit 901.

While the aspects of the disclosure are described with reference to various implementations and exploitations, it will be understood that these aspects are illustrative and that the scope of the claims is not limited to them. In general, techniques for maintaining an entity inventory using a key service and adapting data models to different software versions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. The term “cloud destination” and “cloud source” refer to an entity that has a network address that can be used as an endpoint for a network connection. The entity may be a physical device (e.g., a server) or may be a virtual entity (e.g., virtual server or virtual storage device). In more general terms, a cloud service provider resource accessible to customers is a resource owned/manage by the cloud service provider entity that is accessible via network connections. Often, the access is in accordance with an application programming interface or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on receipt from a first data source of first information that indicates a first set of one or more property values of a first virtual network component, identifying a first property value of the first set of one or more property values to represent the first virtual network component;
associating a first key with the first property value in a first database;
updating a resource inventory with a first entry that indicates the first key and the first information; and
based on receipt from a second data source of second information that indicates a second set of one or more property values of a second virtual network component,
determining that the second set of one or more property values comprises the first property value and that the first key is associated with the first property value; and
based on determining that the first key is associated with the first property value and that the second set of properties values comprises the first property value, aggregating the second information with the first information in the first entry in the resource inventory.

2. The method of claim 1 further comprising:
based on determining that the first key is associated with the first property value, associating the first key with a second property value of the second set of property values in the first database;
determining that a third set of property values of third information from a third data source comprises the second property value, after receipt of the third information from a third data source; and
based on determining that the third set of property values comprises the second property value, aggregating the third information with the first and the second information in the resource inventory.

3. The method of claim 1 further comprising:
based on receipt from the first data source of third information that indicates a third set of one or more property values,
determining that the third set of property values does not comprise a property value indicated in the first database;
associating a second key with a second property value of the third set of property values in the first database; and
updating the resource inventory with a second entry that indicates the second key and the third information.

4. The method of claim 1, wherein determining that the second set of one or more property values comprises the first property value comprises:
querying the first database with one or more property values in the second set of property values; and
receiving the first key in response to the querying.

5. The method of claim 1, wherein aggregating the second information with the first information in the resource inventory comprises:
identifying the first entry in the resource inventory using the first key; and
modifying the first entry to further comprise the second information.

6. The method of claim 1 further comprising, in response to a request for data about resources available within a virtual network, providing a data structure that comprises the first information and the second information.

7. The method of claim 1, wherein identifying the first property value of the first set of one or more property values to represent the first virtual network component comprises:
determining a type of the first virtual network component; and
identifying the first property value based, at least in part, on the type of the first virtual network component.

8. The method of claim 1 further comprising periodically polling services within a virtual network to request information related to virtual network components instantiated within a virtual network.

9. The method of claim 1, wherein the first database stores associations between property values for virtual network components and keys for resources within a virtual network, wherein one or more virtual network components function together to provide a resource within the virtual network, wherein the resource inventory indicates available resources within the virtual network.

10. One or more non-transitory machine-readable media comprising program code for aggregating components within a resource inventory, the program code to:
based on receipt of first information about a first component of a virtual network, determine a first property value from the first information as a first identifier of the first component;
determine whether a key has been assigned to the first identifier in a first database;
based on a determination that a key is not assigned to the first identifier, assign a first key to the first identifier in the first database; and
store the first information in association with the first key in a virtual network resource inventory;
based on a determination that the first identifier is one of a set of one or more identifiers assigned to the first key in the first database,
select an entry in the virtual network resource inventory associated with the first key, wherein the entry comprises information about components which function together to provide a first resource within the virtual network; and
aggregate the first information with the information about the first resource in the selected entry, wherein aggregation is based, at least in part, on the first identifier.

11. The machine-readable media of claim 10 further comprising program code to:
based on receipt of second information about a second component of the virtual network, determine a second property value from the second information as a second identifier of the second component;
based on a determination that the second identifier matches the first identifier and that the first identifier is assigned to the first key, aggregate the second information with the first information in the virtual network resource inventory.

12. An apparatus comprising:
a processor; and
a machine-readable medium having program code executable by the processor to cause the apparatus to,
based on receipt from a first data source of first information that indicates a first set of one or more property values of a first virtual network component, identify a first property value of the first set of one or more property values to represent the first virtual network component;
associate a first key with the first property value in a first database;
update a resource inventory with a first entry that indicates the first key and the first information; and
based on receipt from a second data source of second information that indicates a second set of one or more property values of a second virtual network component,
determine that the second set of one or more property values comprises the first property value and that the first key is associated with the first property value; and
based on a determination that the first key is associated with the first property value and that the second set of properties values comprises the first property value, aggregate the second information with the first information in the resource inventory.

13. The apparatus of claim 12 further comprising program code executable by the processor to cause the apparatus to:
based on a determination that the first key is associated with the first property value, associate the first key with a second property value of the second set of property values in the first database;
determine that a third set of property values of third information from a third data source comprises the second property value, after receipt of the third information from a third data source; and
based on a determination that the third set of property values comprises the second property value, aggregate the third information with the first and the second information in the resource inventory.

14. The apparatus of claim 12 further comprising program code executable by the processor to cause the apparatus to:
based on receipt from the first data source of third information that indicates a third set of one or more property values,
determine that the third set of property values does not comprise a property value indicated in the first database;
associate a second key with a second property value of the third set of property values in the first database; and
update the resource inventory with a second entry that indicates the second key and the third information.

15. The apparatus of claim 12, wherein the program code executable by the processor to cause the apparatus to determine that the second set of one or more property values comprises the first property value comprises program code executable by the processor to cause the apparatus to:
query the first database with one or more property values in the second set of property values; and
receive the first key in response to the querying.

16. The apparatus of claim 12, wherein the program code executable by the processor to cause the apparatus to aggregate the second information with the first information in the resource inventory comprises program code executable by the processor to cause the apparatus to:
identify the first entry in the resource inventory using the first key; and
modify the first entry to further comprise the second information.

17. The apparatus of claim 12 further comprising program code executable by the processor to cause the apparatus to, in response to a request for data about resources available within a virtual network, provide a data structure that comprises the first information and the second information.

18. The apparatus of claim 12, wherein the program code executable by the processor to cause the apparatus to identify the first property value of the first set of one or more property values to represent the first virtual network component comprises program code executable by the processor to cause the apparatus to:
determine a type of the first virtual network component; and
identify the first property value based, at least in part, on the type of the first virtual network component.

19. The apparatus of claim 12 further comprising program code executable by the processor to cause the apparatus to periodically poll services within a virtual network to request information related to virtual network components instantiated within a virtual network.

20. The apparatus of claim 12, wherein the first database stores associations between property values for virtual network components and keys for resources within a virtual network, wherein one or more virtual network components function together to provide a resource within the virtual network, wherein the resource inventory indicates available resources within the virtual network.
